(19) United States
(12) Patent Application Publication
(10) Pub. No.: US 2026/0312473 A1
(43) Pub. Date: Oct. 8, 2026

(54) ROTOR OF A PERMANENTLY EXCITED SYNCHRONOUS MACHINE AND PERMANENTLY EXCITED SYNCHRONOUS MACHINE WITH SUCH A ROTOR

(71) Applicant: Innomotics GmbH, 90441 Nürnberg (DE)

(72) Inventors: Klaus Büttner, Hollstadt (DE); Tobias Katzenberger, Bad Königshofen STT Unteressfeld (DE); Klaus Kirchner, Ostheim (DE); Bastian Plochmann, Neustadt an der Aisch (DE); Matthias Warmuth, Windshausen (DE)

(73) Assignee: Innomotics GmbH, 90441 Nürnberg (DE)

(21) Appl. No.: 19/713,045

(22) Filed: Jun. 18, 2026

Related U.S. Application Data
(62) Division of application No. 18/684,456, filed on Aug. 1, 2022.

(30) Foreign Application Priority Data
Aug. 17, 2021 (EP) 21191716.6

(51) Int. Cl. H02K 15/12; H02K 1/28; H02K 15/03; H02K 21/14

(52) U.S. Cl. CPC H02K 15/12; H02K 1/28; H02K 15/03; H02K 21/14; H02K 2215/00

(57) ABSTRACT

A rotor of a permanently excited synchronous machine includes a laminated core having essentially axial cut-outs with pockets, retaining elements and flux barriers, permanent magnets inserted into the pockets, an end disc and/or distribution disc stacked on an end face of the laminated core and including a feed and an annular channel in communication with the feed, a thixotropic potting compound fed via the feed of the distribution disc and via the annular channel into a space not taken up by the permanent magnets in the cut-outs at an infeed temperature of up to 60° C. at a flow rate of up to 10 mm per second and at a predefinable pressure of up to 10 bar, until at least all axial gaps are filled or until the cut-outs are fully filled with the thixotropic potting compound, and a surface which is free from a lacquer layer or the potting compound.

### CROSS-REFERENCES TO RELATED APPLICATIONS

This application is a divisional of prior filed copending U.S. application Ser. No. 18/684,456, filed Feb. 16, 2024, the priority of which is hereby claimed under 35 U.S.C. § 120, and which is the U.S. National Stage of International Application No. PCT/EP 2022/071566, filed Aug. 1, 2022, which designated the United States and has been published as International Publication No. WO 2023/020824 A1 and which claims the priority of European Patent Application, Serial No. 21191716.6, filed Aug. 17, 2021, pursuant to 35 U.S.C. 119(a)-(d).

The contents of U.S. application Ser. No. 18/684,456, International Application No. PCT/EP2022/071566, and European Patent Application, Serial No. 21191716.6 are incorporated herein by reference in its entirety as if fully set forth herein.

### BACKGROUND OF THE INVENTION

The invention relates to a method for producing a rotor of a permanently excited dynamo-electric machine, a rotor manufactured therewith, a potting compound for producing such a rotor, a permanently excited dynamo-electric machine having such a rotor, and also a use of a permanently excited dynamo-electric machine.

Industrial low-voltage motors (<1 KV rated voltage), particularly in efficiency classes IE4 and higher, are usually manufactured with permanent magnet rotors. The permanent magnets are inserted into the pockets provided for this purpose in the laminated core of the rotor (so-called buried permanent magnets). The geometric dimensions of these pockets must be oversized relative to the permanent magnets in order to allow the permanent magnets to be inserted.

After the permanent magnets have been inserted into the pockets, these permanent magnets must be mechanically fixed to the rotor's laminated core. This is to avoid any play that could cause a change in position of the permanent magnets in the event of mechanical effects such as vibrations, centrifugal forces during operation of the permanently excited dynamo-electric machine or due to magnetic forces.

The permanent magnets are usually glued into the pockets using a reactive plastic adhesive. There are a number of procedures that are commonly used for this purpose.

One option is to apply a paste-like adhesive to the pocket beforehand, which is then pressed into the pocket by the subsequently inserted permanent magnet such that it enfolds the permanent magnet. However, this insertion of the permanent magnets into the paste-like material results a certain degree of positioning inaccuracy, as the displaced paste does not enfold the magnet uniformly and therefore only spot bonding occurs. The handling of the magnetized permanent magnets is not a trivial operation and, because of the magnetic forces involved, cannot be carried out properly in the desired manner without having to clean the previously applied adhesive paste from the tool of an auxiliary device after each magnet insertion.

Another way of fixing the permanent magnets in the pocket is subsequent potting of the pockets containing the permanent magnets using a reactive resin, which must then be cured by thermal action (oven, for example 140° C. for 2 hours). On the one hand, the heating and cooling of the entire rotor is a time-consuming and costly process step that should be avoided.

Moreover, such temperatures can result in partial demagnetization of the permanent magnets.

In addition, it is necessary to adequately seal the component in advance in order to prevent the liquid reactive resin from escaping from the areas for which it is intended. This is necessary on the end faces of the laminated core of the rotor, but also on the outer lateral surface of the rotor, since in regions with thin walls (<1 mm), which are necessary for the optimum magnetic flux, penetration of the individual laminations occurs, resulting in contamination and drip formation on the outer lateral surface. In order to prevent these surfaces from having to be laboriously cleaned and reworked in a downstream process step, the outer lateral surface of the rotor is sealed in advance by a lacquering process. A high-temperature-curing lacquer is also used for this purpose, resulting in an additional process step and a further heating and cooling cycle.

The object of the invention is therefore to provide a rotor for a permanently excited dynamo-electric machine, said rotor being comparatively simple to manufacture and requiring fewer complex process steps. The rotor produced in this way is designed to comply with the required efficiency class for a permanently excited dynamo-electric machine and thus provide comparatively favorable consumption data for the applications of the machine.

### SUMMARY OF THE INVENTION

This object is achieved by a method for producing a rotor, in particular of a permanently excited dynamo-electric machine, by way of the following steps:
stacking a laminated core of the rotor, in particular punch stacking with essentially axially running cut-outs for receiving permanent magnets, wherein the cut-outs have pockets, retaining elements and flux barriers,
inserting the permanent magnets into the pockets,
additional axial stacking of the laminated core by means of at least one distribution disc on an end face of the laminated core, wherein the distribution disc has at least one feed and at least one annular channel,
feeding a thixotropic potting compound under a predefinable pressure via the feed of the distribution disc and via the annular channel into the space not taken up by the permanent magnets in the cut-outs, until at least all the axially running gaps are filled or until the cut-outs are “full”.

The object is achieved by a potting compound for fixing permanent magnets in a rotor of a permanently excited synchronous machine, wherein the base resin material is a two-component reactive resin containing a predefinable amount of thermally conductive additives and/or additives affecting the gel time of the potting compound.

The object is also achieved by a rotor of a permanently excited synchronous machine, produced according to the inventive method, wherein the surface of the rotor is free of lacquer coating or potting compound and the axially running cut-outs are filled with permanent magnets or with potting compound and have end discs/distribution discs.

The object is achieved by a permanently excited dynamo-electric machine having a rotor according to the invention.

The object is also achieved by the use of a permanently excited synchronous machine according to the invention, in particular as an integrated direct drive in compressor drives, fan drives and as drives in the food industry and in marine applications.

According to the invention, the object is achieved by a method for producing the rotor, in particular of a permanently excited dynamo-electric synchronous machine, by using a thixotropic potting compound for fixing and positioning the permanent magnets in a laminated core of the rotor.

Cut-outs are punched-out areas in the laminations, which are arranged axially in series in a stacked manner. The cut-outs have both pockets and flux barriers. The pockets are designed to accommodate the permanent magnet(s). Optionally, webs and/or retaining lugs protrude into the space of the cut-outs for additional fixing and retaining of the permanent magnets against centrifugal forces during production and during operation of the dynamo-electric machine.

The laminations can be stacked on an auxiliary shaft. It is also possible for the laminations to be glued. Punch-stacking of the laminations is also possible in order to obtain a laminated core into which the permanent magnets can be inserted.

Additional stacking takes place when the laminated core is on the actual shaft. The laminated core is pressed together by means of two discs.

At least one of the two discs is a distribution disc.

The laminated core and/or the discs are preferably shrink fit onto the shaft. There are also other ways of transmitting the torque from the laminated core to the shaft, such as feather key connections, etc. Stacking can also take place via tie rod connections.

On the side facing the laminated core of the rotor, the distribution disc has at least one circumferential annular channel that is open toward the laminated core.

On the side of the distribution disc facing away from the laminated core, at least one injection opening, i.e. a feed, is provided to supply the annular channel. Optionally, the annular channel has enlargements in the region of a flux barrier of a pole of the rotor in order to be able to provide sufficient potting compound for the respective pole.

The annular channel and optionally its enlargement provide a form-fit and tight seal with the end face of the laminated core in order to enable the corresponding pressure and thus the required shear forces to be built up.

In the method claimed, the potting compound exhibits thixotropic behavior, wherein the viscosity decreases as a result of an external effect (for example pressure) and returns to the initial viscosity after the stress is removed.

With constant shear (pressure), the viscosity of the potting compound decreases over time-after the shear stress is removed, the viscosity of the potting compound increases again as a function of time. Due to the initially static pressure, but then dynamic pressure as the potting compound moves, viscous flow of the potting compound is initially produced, resulting in the shear forces.

The thixotropy of the potting compound is achieved by adding and dispersing Aerosil fumed silica in the range between 0.1-0.5% by volume.

Before the potting compound is fed to the rotor via a pipe or hose through a distribution disc, its constituents of at least two separately present components are repositioned by relative movement so that there is a uniform and clearly defined distribution of the components to be mixed.

The mixing of at least two components can be carried out by a dynamic mixer, for example a speed mixer.

Static mixing is a technically simpler and more cost-effective option.

The flow channels are branched out via the distribution disc, thereby predefining the path to the cut-outs containing the permanent magnets.

The base resin material is preferably a two-component reactive resin based on epoxy/amine or for example polyurethane/isocyanate. Gelation at ambient temperature can be achieved after a few minutes to a few hours, so that the material is largely solidified without additional heating (and the associated further liquefaction of the resin mixture). In other words, complete curing at ambient temperature is therefore possible without post-curing.

Polysiloxnes and silicone are also suitable base materials.

This results in a shear viscosity of approx. 10\hat{ }5-10\hat{ }7 mPa·s at low shear forces (approx. 10 Pa). At higher shear forces (approx. 200 Pa), a shear viscosity of approx. 10\hat{ }2-10\hat{ }4 mPa·s occurs. These shear forces are introduced into the potting compound by pressure.

Recovery of the material, or rather of the viscosity, occurs within a few minutes after the shear forces decrease (decrease in pressure), so that the potting compound self-solidifies and there are no longer any flow paths through thin gaps, in particular between the individual laminations of the rotor core.

The volume shrinkage of a rotor filled in this way is less than 1%. This avoids, among other things, the formation of shrink holes that could impair the positioning of the permanent magnets and the electromagnetic and heat-conducting properties.

The potting compound, which preferably cures at ambient temperature, can be rendered thermally conductive (>0.5 W/mK) using suitable additives in addition to its highly thixotropic rheological behavior. These additives are mixed into the potting compound before it is fed into the rotor, in particular via the distribution disc. This results in improved heat dissipation from the permanent magnets during operation of the dynamo-electric machine, as they are heated up by eddy currents and/or air-gap harmonics. This means that the permanent magnets are coupled to the rotor laminations with comparatively improved thermal conductivity.

The thermal conductivity of the potting compound can be achieved by adding or mixing in various fillers. The additives used are quartz powder, fused silica, boron nitride (BN), Alox, chalk. The individual components can be added in combination or individually and can therefore account for up to 40% by volume of the total potting compound.

Advantageously, the rotor is filled with potting compound as a bottom-up process at increased potting pressure.

Bottom-up potting ensures bubble-free application.

A static/dynamic mixing tube is used to mix the reactive mixture in situ and then apply it directly to the rotor via the distribution disc on an end face of the rotor. Distribution discs can also be provided on both ends of the rotor in order to fill the rotor from both sides. In this case, the distribution discs are either identical or designed such that each distribution disc only applies potting compound to half of the rotor poles. Bilateral injection of potting compound can be particularly advantageous in the case of axially long rotors.

Pressures of up to 10 bar, preferably 4.5 bar, can be applied via one or more suitable injection ports on the distributor disc, so that the freshly mixed, thixotropic potting compound becomes flowable and reaches the remaining geometric spaces of the rotor axially, in particular in an axially bottom-up manner.

The thixotropic potting compound is thus mixed in situ in a static or dynamic mixing tube, wherein the potting compound is fed in at a temperature of up to 60° C., in particular up to 30° C., and is distributed at a flow rate of up to 10 mm per second, wherein a pressure of up to 10 bar, in particular 4.5 to 5 bar, prevails.

The potting process can therefore take place at virtually ambient temperature, which simplifies the process and enables the rotor to be further processed almost seamlessly timewise.

By spaces are meant the flux barriers, the gaps between the permanent magnets and the respective laminations, optionally feed channels, but not, or barely, the slots between the individual laminations. In other words, the radial planes between the individual laminations must not and will not be provided with the potting compound. Potting compound in these radial planes should be avoided. The potting compound fills solely and exclusively the cut-outs that have permanent magnets, i.e. the flux barriers and the gaps between the laminations and the permanent magnets, but no radial gaps between the individual laminations, i.e. the planes that are perpendicular to the axis.

Once the cut-outs have been completely filled, the pressure is released. Detection that the laminated core with the crucial spaces is “full” is carried out via the static compared to the dynamic pressure (detection for example via pressure build-up dynamic vs. static pressure). As soon as all the flow channels are completely filled, the flow of potting compound ceases and can be detected by a change in the total pressure according to Bernoulli. Bernoulli's pressure equation (total pressure=dynamic pressure+static pressure).

It is also possible to carry out a visual inspection to detect any undesirable leakage on the outside of the lateral surface of the cylindrical laminated core, preferably at the narrow webs that act as the edge boundaries of the flux barriers to the lateral surface. Viewed radially, these can be just a few millimeters or even fractions of a millimeter.

The potting compound in the rotor then gels without pressure at ambient temperature and cures completely within 24 hours.

Further work on and with the rotor without mechanical stress is possible after approx. 1 hour. Penetration of the material, i.e. the potting compound, through the individual laminations is prevented by the potting compound becoming thixotropic, thereby obviating the need for prior lacquering of the outer lateral surface.

A suitable distribution disc, which is provided on at least one end face of the rotor's laminated core during the potting process, connects an annular channel via one or more feeds on the distribution disc to all the distribution channels that can be optionally provided in order to “fill” the rotor by a single injection of the potting material as a filling process.

The distribution disc thus performs a plurality of functions; stacking the laminated core on the shaft, distributing the potting material and possibly providing balancing options. The rotor is balanced by removing material or additionally attaching balancing weights.

This distribution disc is attached to the end face of the laminated core in a form-fit manner and can subsequently also be used for balancing the rotor.

According to the invention, the rotor with its permanent magnets is now potted using a highly filled, thixotropic potting compound, which gels and cures completely at ambient temperature.

Due to the high degree of filling and use of thixotropic additives, the pockets can be filled from the bottom up using a pressure process, but without the reactive compound being able to escape through small slits, for example between the individual laminations.

A synchronous machine equipped with such a rotor has a high efficiency class and is therefore suitable for driving compressors, conveyor belts, fans, etc., especially for continuous operation.

### BRIEF DESCRIPTION OF THE DRAWING

The invention and further advantageous embodiments of the invention will now be explained in more detail with reference to exemplary embodiments illustrated in principle, wherein:

FIG. 1 shows a schematic longitudinal view of a dynamo-electric machine,

FIG. 2 shows a rotor according to the invention,

FIG. 3 shows a distribution disc,

FIG. 4 shows a pole of a rotor with permanent magnets,

FIG. 5 shows a partial view of a pole of the rotor,

FIG. 6 shows the basic process sequence for producing a rotor,

FIG. 7 shows a partial cross-section of a rotor pole filled with potting compound,

FIG. 8 shows a partial cross-section of a rotor pole cut-out filled with potting compound.

### DETAILED DESCRIPTION OF PREFERRED EMBODIMENTS

It should be noted that terms such as “axial”, “radial”, “tangential”, etc. refer to the axis 7 used in the respective figure or in the particular example described. In other words, the directions axial, radial and tangential always refer to an axis 7 of the rotor 5 and thus to the corresponding axis of symmetry of the stator 2. “Axial” describes a direction parallel to the axis 7, “radial” describes a direction orthogonal to the axis 7, toward or away from it, and “tangential” is a direction describing a circle around the axis 7 at a constant radial distance from the axis 7 and at a constant axial position. The term “circumferential” is to be equated with “tangential”.

In respect of a surface, for example a cross-sectional surface, the terms “axial”, “radial”, “tangential” etc. describe the orientation of the normal vector of the surface, i.e. the vector that is perpendicular to the surface in question.

The term “coaxial components”, for example coaxial components such as rotor 5 and stator 2, is to be understood here as meaning components that have the same normal vectors, i.e. for which the planes defined by the coaxial components are parallel to each other. Moreover, the term is intended to imply that the centers of coaxial components lie on the same axis of rotation or symmetry. However, these center points may be located at different axial positions on this axis and the planes mentioned may therefore have a distance >0 from each other. The term does not necessarily require that coaxial components have the same radius.

In the context of two components that are “complementary” to one another, the term “complementary” means that their outer shapes are designed such that one component can preferably be completely arranged in the component that is complementary to it, so that the inner surface of one component and the outer surface of the other component are ideally in contact without gaps, i.e. over their entire surface. Consequently, in the case of two complementary objects, the outer shape of one object is determined by the outer shape of the other object. The term “complementary” could be replaced by the term “inverse”.

For the sake of clarity, in some cases where components are present more than once, not all of the components shown are provided with reference characters in the figures.

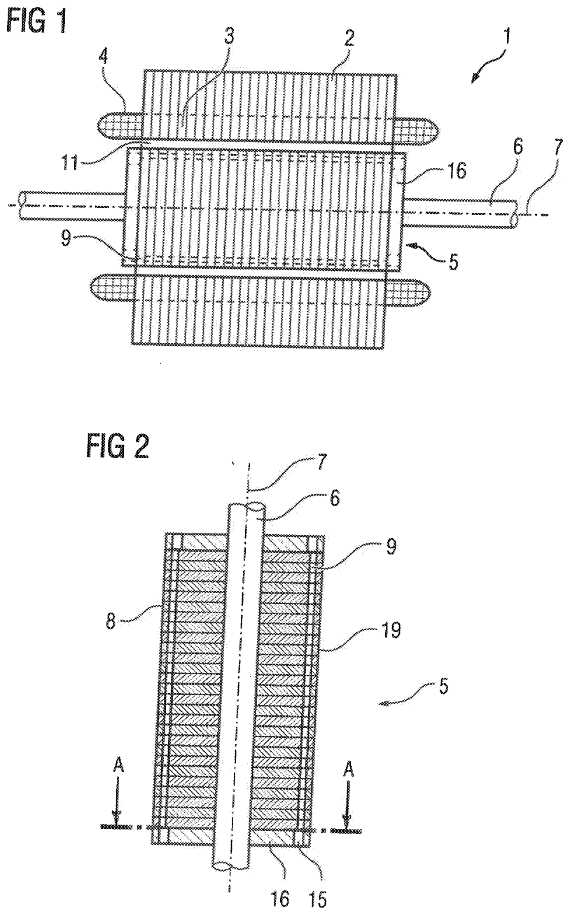

FIG. 1 shows a schematic longitudinal view of a dynamo-electric machine 1, in this case a permanently excited synchronous machine. This permanently excited synchronous machine has a stator 2 which has a winding system 3 in grooves (not shown in detail) which forms a winding overhang 4 on the end faces of the stator 2. Electromagnetic interaction via an air gap 11 causes a rotor 5 to rotate about an axis 7 by means of an energized winding system 3. The rotor 5, which is arranged coaxially with respect to the stator 2, has permanent magnets 9, which are also referred to as buried permanent magnets 9, arranged in axially running cut-outs. The laminations 8 of the rotor 5 are stacked and non-rotatably connected to a shaft 6.

FIG. 2 shows a rotor 5, the laminations of which are stacked by two end discs, wherein at least one end disc is designed as a distribution disc 16. On the side facing an end face of the rotor's laminated core, said distribution disc 16 has at least one annular channel 18 which can be filled via a feed 15. A thixotropic material is now applied under pressure to the annular channel 18 and any additional enlargements 17 via this feed 15.

The distribution disc 16 can also have a plurality of feeds 15 in order to increase the amount of potting material that can be fed in.

Cut-outs in the laminated core are punched out sections of the individual sheets which are arranged axially in series in a stacked manner. The cut-outs have pockets 10 and also the flux barriers 13. The pockets 10 are designed to accommodate the permanent magnet(s) 9. Optionally, webs and/or retaining lugs project into the space of the cut-outs for additional fixing and support of the permanent magnets 9 against centrifugal forces during production and during operation of the dynamo-electric machine.

Ideally, the permanent magnets 9 are placed in the cut-outs without gaps to the laminations-thus forming a seamless and full-surface contact. However, a complementary arrangement of this kind is not possible for manufacturing reasons. The production process creates gaps between the permanent magnets 9 and the laminations 8 which have to be closed.

The laminations 8 can be stacked on an auxiliary shaft. It is also possible for the laminations 8 to be glued. The laminations 8 can also be stamp-stacked to create a laminated core for the rotor 5 into which the permanent magnets 9 can be inserted.

Additional stacking takes place when the laminated core is on the actual shaft 6. The laminated core is pressed together by means of two discs, in particular at least one distribution disc 16.

The laminated core and/or the distribution discs are preferably shrunk onto the shaft 6. Other means of transferring the torque from the laminated core to the shaft are also available, such as feather key connections, etc. The laminated core can also be stacked using tie rod connections.

On the side facing the laminated core of the rotor 5, the distribution disc 16 has at least one circumferential annular channel 18 that is open toward the laminated core and makes a form-fit and tight seal with the end face of the laminated core.

At least one injection opening, i.e. a feed 15, is provided on the side of the distribution disc 16 facing away from the laminated core in order to feed the annular channel 18. Optionally, the annular channel 18 has enlargements 17 in the region of a flux barrier of a pole of the rotor in order to be able to provide sufficient potting compound for the respective pole.

The annular channel 18 and optionally its enlargement 17 make a form-fit and tight seal with the end face of the laminated core in order to ensure a corresponding pressure seal in order to build up the corresponding pressure and thus the required shear forces.

The potting compound 20, which has been mixed in advance, in particular in situ, is now pressed into the laminated core of the rotor 5 at a predefinable pressure via the feed 15.

This potting compound 20, which is implemented as a thixotropic material, has a comparatively low viscosity due to the increased shear forces, which enables the potting compound to penetrate into the gaps and cut-outs of the laminated core that are occupied by permanent magnets 9. During the potting process, the potting compound is now forced in under a predefinable pressure and, due to the lower viscosity, it is distributed in the flux barriers or gaps between permanent magnets 9 in the laminated core. Pressure monitoring can stop the process, so that, the moment the shear forces are reduced (pressure reduction) and the potting compound undergoes an increase in viscosity, the potting process is or can be terminated. As soon as the potting compound has distributed itself in the gaps and flux barriers around the permanent magnet 9 and further expansion into the spaces between the laminations is imminent, the required pressure increases, which can then be applied as a criterion for terminating the potting process. This avoids the potting compound penetrating radially between the laminations of the rotor 5, for example, and in particular from coming into contact with the surface 19 of the rotor 5.

The thixotropic potting compound 20 is thus mixed in situ in a static or dynamic mixing tube, wherein the potting compound 20 has a temperature of up to 60° C., in particular up to 30° C., and is fed at a flow rate of up to 10 mm per second, wherein a pressure of up to 10 bar, in particular 4.5 to 5 bar, prevails.

The process of potting the permanent magnets 9 in the cut-outs can therefore be carried out almost at ambient temperature, which simplifies the process and enables the rotor 5 to be further processed almost seamlessly timewise.

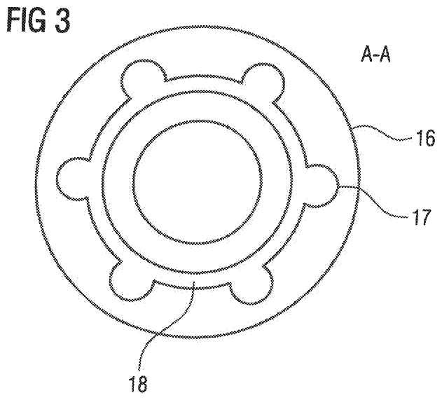

FIG. 3 shows a section through the distribution disc 16 in which a circumferential annular channel 18 is provided and which, as an optional design, has enlargements 17, each supplying a pole of the rotor 5 with potting compound 20.

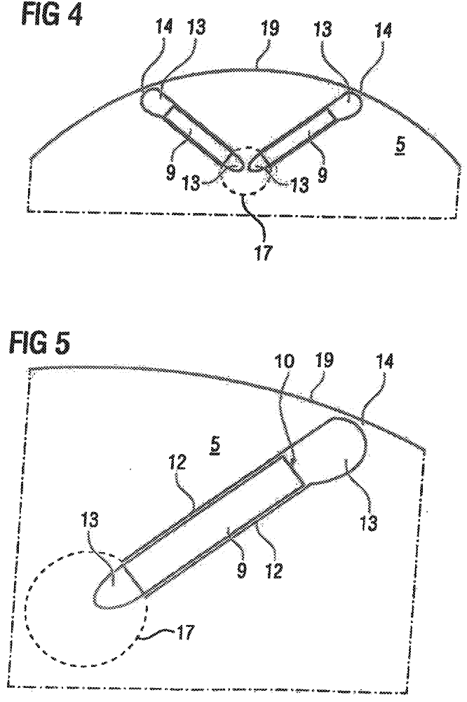

FIG. 4 shows a pole of the rotor 5 which in this case is formed by two permanent magnets 9 arranged in a V-shape. The poles of the rotor 5 can also be formed from a plurality of permanent magnets 9, for example from double V-shaped arrangements, from U-shaped arrangements or W-shaped arrangements or also only from tangentially arranged permanent magnets 9. A plurality of permanent magnets 9 are also provided for each cut-out in the axial direction, depending on the axial length of the rotor 5.

The permanent magnets 9 are arranged in cut-outs, with a cut-out consisting of flux barriers 13, any optional retaining elements, and pockets 10. The pockets 10 are designed to accommodate the permanent magnets 9, while the flux barriers 13 and any retaining elements merely serve to fix or optimize the magnetic flux in the laminated core of the rotor 5.

An enlargement 17 is indicated which optionally leads from the distributor disc 16 and the annular channel 16 into the pole of the rotor 5.

In this case, the potting compound 20 would be pressed in axially via the adjacent flux barriers 13, wherein the potting compound 20 then finds another path between the permanent magnets 9 and the laminations in order to penetrate into the radially outer flux barriers 13 and fill them also. By monitoring the pressure and thus the shear forces, the process can be stopped as soon as the “cutouts are full”. This avoids the potting compound 20 reaching the surface 19 of the rotor 5, particularly via the narrow webs 14 on the radially outer edge of the rotor.

FIG. 5 shows the embodiments according to FIG. 4 in more detail, wherein the gaps 12 between the laminations of the rotor 5 and the permanent magnets 9 are more clearly illustrated. It can be seen that the gaps 12 between the laminations and the permanent magnets 9 can have at least partial enlargements in order to facilitate filling by the potting compound 20.

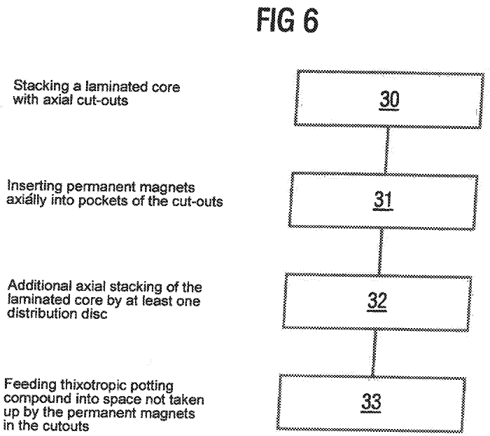

FIG. 6 shows the basic steps of the process for producing the rotor 5, in particular the permanently excited dynamo-electric machine 1, by way of the following steps:
Step 30: stacking the laminated core of the rotor 5, in particular punch stacking with essentially axially running cut-outs for accommodating the permanent magnets 9, wherein the cut-outs have pockets 10, retaining elements and flux barriers 13,
Step 31: inserting the permanent magnets 9 axially into the pockets 10 of the cutouts,
Step 32: additional axial stacking of the laminated core by means of at least one distribution disc 16 on the end face of the laminated core, wherein the distribution disc 16 has at least one feed 15 on the side facing away from the laminated core and at least one annular channel 18 on the side facing the laminated core,
Step 33: feeding the thixotropic potting compound 20, mixed in situ in a static or dynamic mixing tube, under a predefinable pressure of up to 10 bar, in particular 4.5 to 5 bar, at a temperature of up to 60° C., in particular up to 30° C., at a flow rate of up to 10 mm per second, via the feed 15 of the distribution disc 16, via the annular channel 18 into the space not taken up by the permanent magnets 9 in the cutouts until at least all the axially running gaps 12 are filled or until the cutouts are “full” and/or a pressure increase significantly greater than the processing pressure, in particular 10 bar, is detected (detection of the dynamic versus static pressure of the potting compound 20).

The thixotropic potting compound 20 is mixed in situ in a static or dynamic mixing tube.

The rotor 5 can be positioned in an auxiliary device such that the axial gaps 12 in particular are filled parallel to the axis by means of the rising potting compound 20.

During the process of filling with potting compound, the filling of the rotor 5 is monitored by detecting the dynamic versus static pressure of the potting compound 20.

Particularly if the pressure of the potting compound 20 is different from the ambient pressure, i.e. below or above it, it is advantageous if the distribution disc 16, and in particular the annular channel 18, makes a form-fit seal with the end face of the rotor 5 in order to ensure loss-free feeding of the potting compound 20 into the rotor 5.

As the base resin material of the potting compound 20, a two-component reactive resin is provided in which thermally conductive additives and/or additives that affect the gelling time of the potting compound are present or can be added in a predefinable quantity.

The two-component reactive resin can be based on epoxy/amine or polyurethane/isocyanate.

In addition, thermally conductive additives such as quartz flour and/or fused silica and/or BN and/or Alox and/or chalk can be added, which in total or individually account for up to 40% by volume of the potting compound 20. This creates a thermal connection between the permanent magnets 9 and the laminated core.

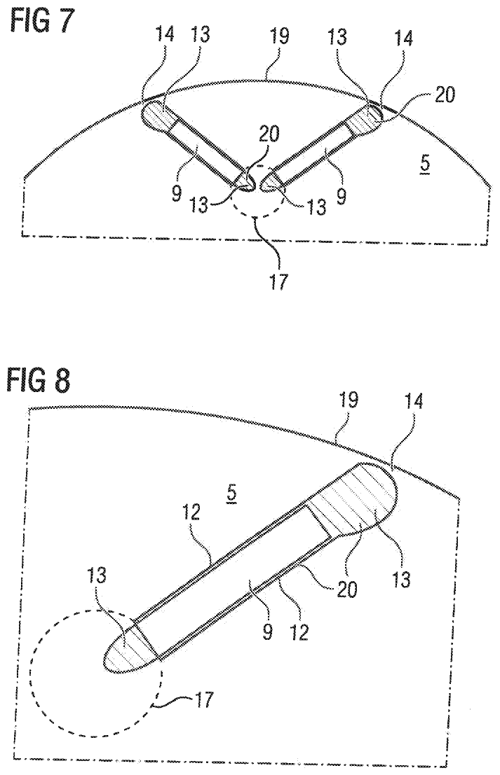

FIG. 7 and FIG. 8 show cut-outs in the laminated core that are filled with the potting compound 20. The gaps 12 and the flux barriers 13 in the laminated core are filled with potting compound 20, but not the spaces between the individual laminations 8, which extend perpendicular to the axis 7.

The method according to the invention using the thixotropic potting compound 20 makes the production of such a rotor 5 particularly simple.

A permanently excited synchronous machine with a rotor 5 according to the invention, the permanent magnets 9 of which are arranged in a buried arrangement and are fixed using a thixotropic potting compound of this kind, achieves a comparatively high degree of efficiency and is therefore particularly suitable for many machines, especially those that are in continuous operation. These are used, for example, as drives for compressors, fans and as drives in the food industry and in marine applications.

The fact that the surface of the rotor is free of residues of potting compounds or adhesives means that the radial air gap thickness between stator 2 and rotor 5 can also be reduced.

This results in a comparatively higher power density for the same drive volume. Among other things, this means that the permanently excited synchronous machine can be arranged comparatively close to the driven machine and can therefore also be incorporated into the housing of one of the above-mentioned driven machines as a direct drive.

The thixotropic potting compound can also be used to encapsulate the flux barriers of the rotors of a reluctance machine in order to obtain a stable and compact rotor.

What is claimed is:

1. A rotor of a permanently excited synchronous machine, the rotor comprising:
a laminated core including essentially axial cut-outs which have pockets, retaining elements and flux barriers;
permanent magnets inserted into the pockets;
an end disc and/or distribution disc stacked on an end face of the laminated core and including at least one feed and at least one annular channel in communication with the at least one feed;
a thixotropic potting compound fed via the at least one feed of the distribution disc and via the at least one annular channel into a space not taken up by the permanent magnets in the cut-outs at an infeed temperature of up to 60° C., in particular up to 30° C., at a flow rate of up to 10 mm per second and at a predefinable pressure of up to 10 bar, in particular 4.5 to 5 bar, until at least all axial gaps are filled or until the cut-outs are fully filled with the thixotropic potting compound; and
a surface which is free from a lacquer layer or the potting compound.

2. The rotor of claim 1, wherein the distribution disc has ends facing away from the end face of the laminated core, the distribution disc being a balancing disc by attaching balancing weights to the ends of the distribution disc or by removing material from the distribution disc.

3. A permanently excited dynamo electric machine, in particular a permanently excited synchronous machine, the permanently excited dynamo electric machine comprising the rotor of claim 1.

4. The permanently excited synchronous machine of claim 3 for use in particular as an integrated direct drive in a compressor drive, fan drive and as a drive in the food industry and in a marine application.
